(19) United States
(12) Patent Application Publication
(10) Pub. No.: US 2017/0283204 A1
(43) Pub. Date: Oct. 5, 2017

(54) IMAGE FORMING SYSTEM

(71) Applicant: FUJI XEROX CO., LTD., Tokyo (JP)

(72) Inventors: Hiroaki AWANO, Kanagawa (JP); Yoshinori NAKANO, Kanagawa (JP); Takuya MAKITA, Kanagawa (JP); Kojiro TSUTSUMI, Kanagawa (JP); Katsumi HARADA, Kanagawa (JP); Yasuhiro KUSUMOTO, Kanagawa (JP); Hiroshi HAGIWARA, Kanagawa (JP); Emiko SHIRAISHI, Kanagawa (JP); Junichi HIROTA, Kanagawa (JP)

(73) Assignee: FUJI XEROX CO., LTD., Tokyo (JP)

(21) Appl. No.: 15/217,289

(22) Filed: Jul. 22, 2016

(30) Foreign Application Priority Data
Mar. 29, 2016 (JP) 2016-066604

(51) Int. Cl. B65H 37/04; B31F 5/02

(52) U.S. Cl. CPC B65H 37/04; B31F 5/02; B65H 2801/24; B65H 2801/48

(57) ABSTRACT

There is provided an image forming system including an apparatus body including an image forming unit configured to form an image on a sheet, a first sheet processing device mounted on the apparatus body, and configured to perform a first binding processing on plural sheets each of which is formed with an image by the image forming unit, and a second sheet processing device mounted on the apparatus body at a position different from that of the first sheet processing device, and configured to perform a second binding processing different from the first binding processing on the plural sheets, each of which is formed with an image by the image forming unit.

### CROSS-REFERENCE TO RELATED APPLICATIONS

This application is based on and claims priority under 35 USC 119 from Japanese Patent Application No. 2016-066604 filed Mar. 29, 2016.

### BACKGROUND

### Technical Field

The present invention relates to an image forming system.

### SUMMARY

According to an aspect of the invention, there is provided an image forming system including an apparatus body including an image forming unit configured to form an image on a sheet, a first sheet processing device mounted on the apparatus body, and configured to perform a first binding processing on plural sheets each of which is formed with an image by the image forming unit, and a second sheet processing device mounted on the apparatus body at a position different from that of the first sheet processing device, and configured to perform a second binding processing different from the first binding processing on the plural sheets, each of which is formed with an image by the image forming unit.

### BRIEF DESCRIPTION OF THE DRAWINGS

Exemplary embodiments of the present invention will be described in detail based on the following figures, wherein:

FIG. 1 is a view illustrating an entire configuration of an image forming system according to a first exemplary embodiment;

FIG. 2 is a view illustrating configurations of a first sheet processing device and a second sheet processing device, and illustrating the upper part of the image forming system illustrated in FIG. 1 in an enlarged scale;

FIG. 3 is a view illustrating an internal structure of the first sheet processing device;

FIG. 4 is a view illustrating the first sheet processing device when viewed from above, in the direction orthogonal to a page surface of a sheet to be transported;

FIGS. 5A and 5B are views illustrating a needle-free binding mechanism according to the present exemplary embodiment;

FIG. 6 is a flowchart illustrating a procedure of selection by a controller; and

FIG. 7 is a view illustrating an overall configuration of an image forming system according to a second exemplary embodiment.

### DETAILED DESCRIPTION

### First Exemplary Embodiment

Hereinafter, an exemplary embodiment of the present invention will be described with reference to the accompanying drawings.

### (Description of Image Forming System 1)

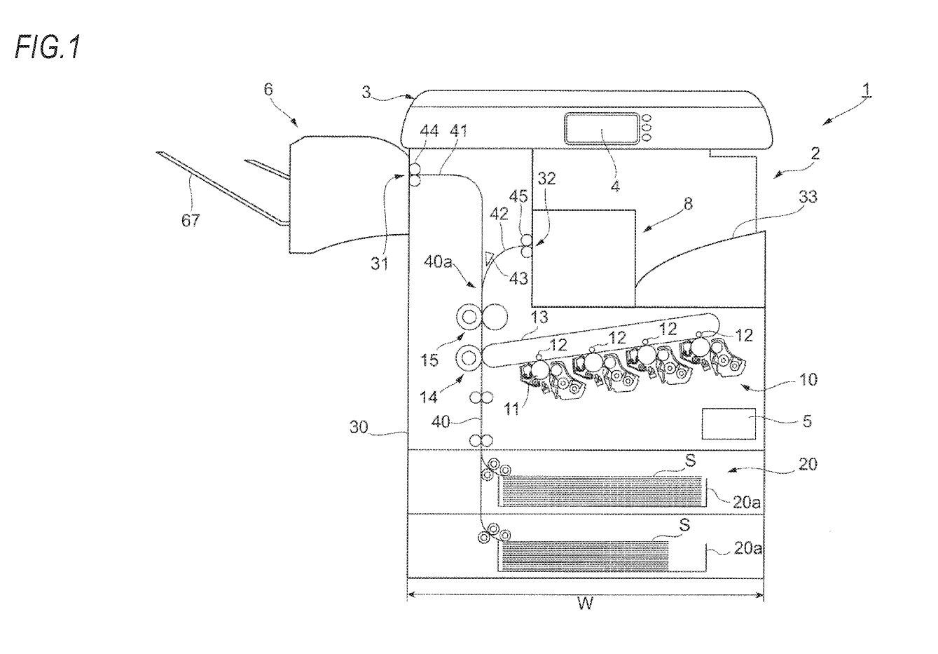

FIG. 1 is a view illustrating an overall configuration of an image forming system 1 according to the present exemplary embodiment. The image forming system 1 according to the first exemplary embodiment includes, for example, an image forming apparatus 2 that forms an image on a sheet, an image reader 3 that reads an image formed on an original document, and an operation reception apparatus 4 that receives operation instructions from a user and displaying various information with respect to the user. The image forming system 1 includes, for example, a central processing unit (CPU), a read only memory (ROM), a random access memory (RAM), and includes a controller 5 that controls an operation of the image forming system 1, as an example of a selection unit. In this example, the image reader 3 and the operation reception apparatus 4 are provided at a vertically upper part of the image forming apparatus 2. The controller 5 is provided inside a housing 30, which will be described later, of the image forming apparatus 2.

Furthermore, the image forming system 1 includes a first sheet processing device 6 that performs a first binding processing (needle-free binding processing) on a sheet on which an image is formed by the image forming apparatus 2 and a second sheet processing device 8 that performs a second binding processing (needle binding processing), which is different from the first binding processing, on a sheet on which an image is formed by the image forming apparatus 2. In the image forming system 1 of the present exemplary embodiment, each of the first sheet processing device 6 and the second sheet processing device 8 are detachably provided to the housing 30, which will be described later, of the image forming apparatus 2.

In the image forming system 1 of the present exemplary embodiment, as illustrated in FIG. 1, the first sheet processing device 6 is provided outside a range of an installation surface (hereinafter, referred to as an “installation range W”) on which the image forming apparatus 2 is installed. The second sheet processing device 8 is provided inside the installation range W of the image forming apparatus 2. In the description of the present exemplary embodiment, the installation range W of the image forming apparatus 2 means a range surrounded by the housing 30 positioned at the outermost side of the image forming apparatus 2 when viewing the image forming apparatus 2 from a vertically upper side (the upper side of FIG. 1).

In the image forming system 1, as illustrated in FIG. 1, the height of the first sheet processing device 6 from an installation surface, on which the image forming apparatus 2 is installed, is higher than the height from the installation surface of the image forming apparatus 2 to the second sheet processing device 8. In other words, in the image forming system 1, the first sheet processing device 6 is mounted at the vertically upper side compared to the second sheet processing device 8.

Details of, for example, the configurations of the first sheet processing device 6 and the second sheet processing device 8, the first binding processing performed in the first sheet processing device 6, and the second binding processing performed in the second sheet processing device 8 will be described in detail in the following sections.

### (Description of Image Forming Apparatus 2)

The image forming apparatus 2 includes an image forming unit 10 that is configured in a so-called tandem type and forms an image based on color image data and a sheet supply unit 20 that includes plural paper trays 20a (two (2) paper trays in this example) each configured to accommodate sheets S and supplies the sheets S to the image forming unit 10. The image forming apparatus 2 includes a housing 30 as an example of an apparatus body in which the image forming unit 10 and the sheet supply unit 20 are accommodated. The image forming apparatus 2 includes a sheet transport path 40 in which a sheet is transported from the sheet supply unit 20 to the first sheet processing device 6 and the second sheet processing device 8 through the image forming unit 10.

The image forming unit 10 includes four (4) photoconductor drums 11 corresponding to four colors of black (K), yellow (Y), magenta (M), and cyan (C), respectively, and arranged in parallel to each other in a horizontal direction, four primary transfer rolls 12 arranged to correspond to the four photoconductor drums 11, respectively, an intermediate transfer belt 13 onto which toner images formed on respective photoconductor drums 11 is primarily transferred in sequence, a secondary transfer roll 14 that secondarily transfers the toner images, which are primarily transferred on the intermediate transfer belt 13, onto the sheet S, and a fixing device 15 that fixes the toner images to the sheet S after the secondary transfer.

Around each of the photoconductor drums 11, for example, a charging unit (not illustrated) that charges a surface of the photoconductor drum 11, a laser writing apparatus (not illustrated) that forms an electrostatic latent image by irradiating laser light on the surface of the photoconductor drum 11 charged by the charging unit, a developing unit (not illustrated) that develops the electrostatic latent image formed on the photoconductor drums 11 using respective color toners to visualize the electrostatic latent image, and a cleaner (not illustrated) that removes toner remaining on the photoconductor drums 11 after the primary transfer, are disposed.

On the contrary, each of the primary transfer rolls 12 is disposed to be opposite to the corresponding one of the photoconductor drums 11 across the intermediate transfer belt 13. The primary transfer rolls 12 primarily transfer toner images formed on the corresponding photoconductor drums 11 onto the intermediate transfer belt 13, respectively. In addition, the intermediate transfer belt 13 is stretched in a loop shape by plural support rolls (not illustrated).

The secondary transfer roll 14 is provided to be opposite to the intermediate transfer belt 13. The secondary transfer roll 14 collectively and electrostatically transfers (secondarily transfers) respective color toner images, which have been primarily transferred in sequence on the intermediate transfer belt 13, to the sheet S.

The fixing device 15 includes, for example, a heating member having a heat source therein and a pressing member that forms a pressing section with the heating member. When the sheet S passes through the pressing section, the toner images are fixed to the sheet S by being heated and pressed.

In the image forming unit 10, the sheet S is supplied from the sheet supply unit 20 to the secondary transfer roll 14 according to timing at which each color toner image on the intermediate transfer belt 13 is transported to an arrangement position of the secondary transfer roll 14. As a result, the color toner images are collectively and electrostatically transferred to the sheet S by the action of a transfer electric field formed by the secondary transfer roll 14.

Thereafter, the sheet S, on which each color toner image is secondarily transferred, is peeled off from the intermediate transfer belt 13, and transported to the fixing device 15. In the fixing device 15, each color toner image is fixed to the sheet S by a fixing processing with heat and pressure and a color image is formed on the sheet S. The sheet S, on which the color image is formed, is discharged from the image forming apparatus 2, and transported to the first sheet processing device 6 or the second sheet processing device 8 connected to the image forming apparatus 2.

As illustrated in FIG. 1, the housing 30 generally has a substantially rectangular parallelepiped shape and accommodates, for example, respective components of the image forming unit 10 and the sheet supply unit 20, and the controller 5.

The housing 30 includes a first exit port 31 that discharges the sheet S on which an image is formed in the image forming unit 10 toward the first sheet processing device 6 and a second exit port 32 that discharges the sheet S on which an image is formed in the image forming unit 10 toward the second sheet processing device 8. As illustrated in FIG. 1, in this example, a height from an installation surface on which the image forming apparatus 2 is installed to the first exit port 31 is higher than a height from the installation surface of the image forming apparatus 2 to the second exit port 32. In this example, a discharged direction of the sheet S discharged from the first exit port 31 is opposite to a discharged direction of the sheet S discharged from the second exit port 32.

In addition, the housing 30 includes a body side stacking unit 33 in which, for example, the sheet S or a sheet bundle discharged from the second sheet processing device 8, as another example of the stacking unit.

Furthermore, the housing 30 includes a first mounting unit (not illustrated) provided adjacent to the first exit port 31. A first housing 66 of the first sheet processing device 6, which will be described later, is mounted on the first mounting unit. The housing 30 includes a second mounting unit (not illustrated) provided adjacent to the second exit port 32. A second housing 86 of the second sheet processing device 8, which will be described later, is mounted on the second mounting unit.

As illustrated in FIG. 1, the sheet transport path 40 includes a branch section 40a, at which the transport directions of the sheet S are branched, at the downstream side of the fixing device 15 in the image forming unit 10. The sheet transport path 40 includes a first transport path 41 in which the sheet S is transported from the branch section 40a toward the first exit port 31 and a second transport path 42 in which the sheet S is transported from the branch section 40a toward the second exit port 32. In this example, the length of the second transport path 42 (the length from the branch section 40a to the second exit port 32) is shorter than the length of the first transport path 41 (the length from the branch section 40a to the first exit port 31).

At the branch section 40a of the sheet transport path 40, a distribution mechanism 43 is provided to distribute the sheets S, which are transported from the image forming unit 10 to the branch section 40a, to the first transport path 41 or the second transport path 42. The distribution mechanism 43 distributes the sheets S, which are transported to the branch section 40a, to the first transport path 41 or the second transport path 42 based on the control by the controller 5.

The first transport path 41 of the sheet transport path 40 is provided with first discharge rolls 44 to discharge the sheets S, which are transported to the first transport path 41, from the first exit port 31 toward the first sheet processing device 6. In addition, the second transport path 42 of the sheet transport path 40 is provided with second discharge rolls 45 to discharge the sheets S, which are transported to the second transport path 42, from the second exit port 32 toward the second sheet processing device 8.

In the first transport path 41, a sheet S on which an image is formed in the image forming unit 10 is transported in a state where the surface formed with the image (image forming surface) is directed vertically upward (face-up state). In addition, the sheet S is discharged from the first exit port 31 to the first sheet processing device 6 by the first discharge rolls 44 in a state where the image forming surface is directed vertically upward. On the other hand, in the second transport path 42, a sheet S on which an image is formed in the image forming unit 10 is transported in a state where the image forming surface is directed vertically downward (face-down state). The sheet S is discharged from the second exit port 32 to the second sheet processing device 8 by the second discharge rolls 45 in a state where the image forming surface is directed vertically downward.

Subsequently, the first sheet processing device 6 and the second sheet processing device 8 will be described.

### (Description of First Sheet Processing Device 6)

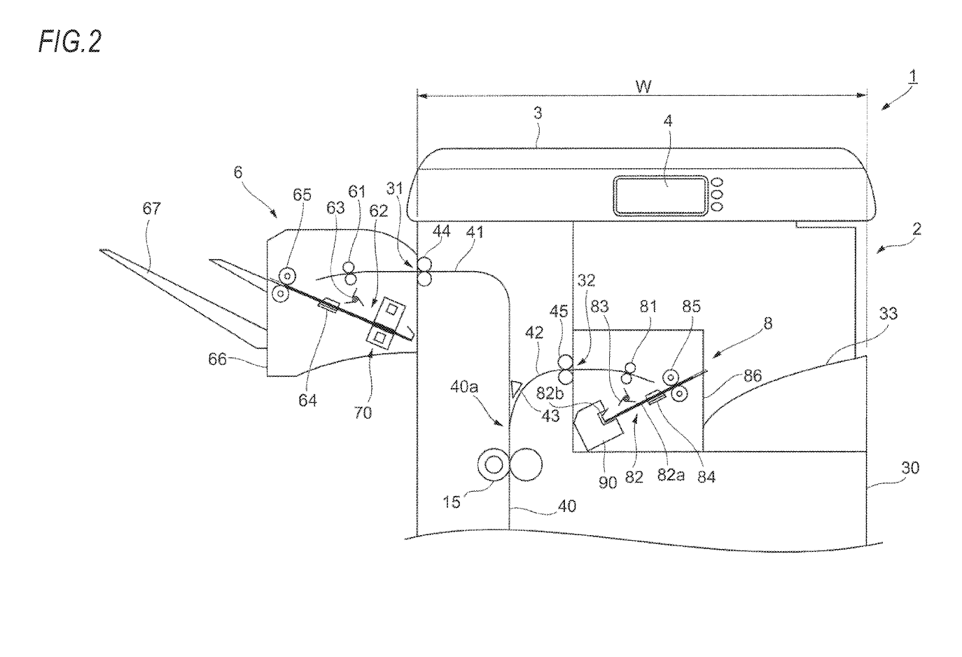

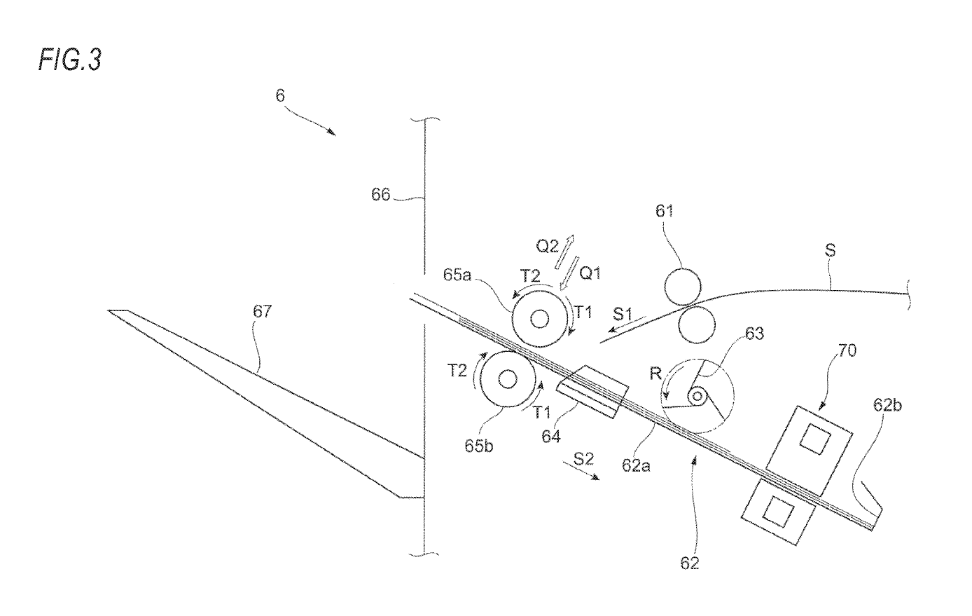

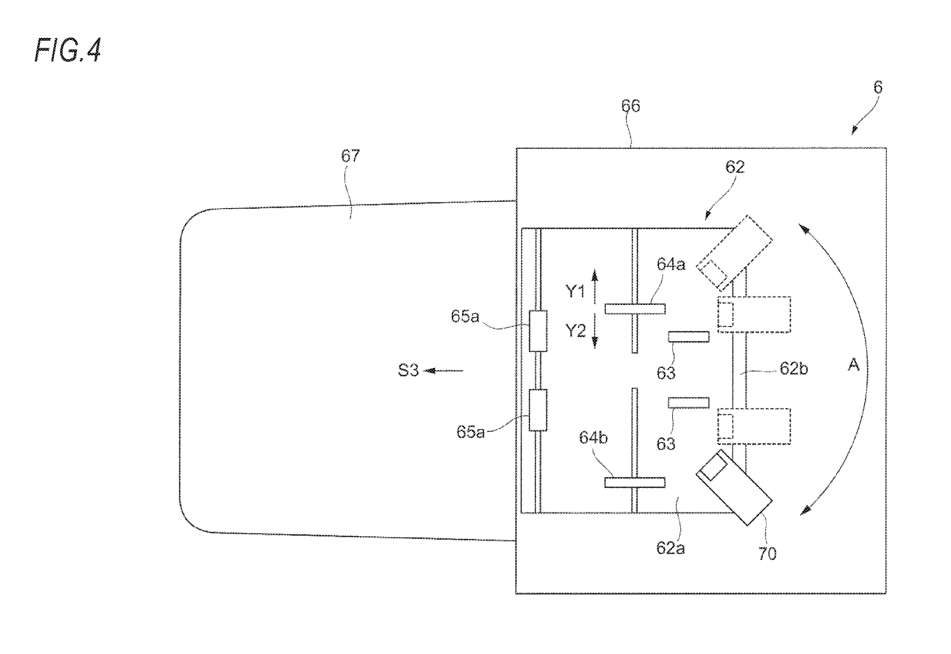

FIG. 2 is a view illustrating a configuration of the first sheet processing device 6 and the second sheet processing device 8, and illustrating the upper part of the image forming system 1 illustrated in FIG. 1 in an enlarged scale. In addition, FIG. 3 is a view illustrating an internal structure of the first sheet processing device 6. FIG. 4 is a view illustrating the first sheet processing device 6 when viewed from the top side in the direction orthogonal to the surface of a sheet S to be transported.

The first sheet processing device 6 of the present exemplary embodiment includes first transport rolls 61 that transport a sheet S discharged from the first exit port 31 of the image forming apparatus 2 further to the downward side and a first compiling tray 62 in which only the predetermined number of sheets S are accumulated after an image is formed on each of the sheets S. In addition, the first sheet processing device 6 includes a first rotating paddle 63 that presses a rear end of the sheet S toward an end guide 62b, which will be described later, of the first compiling tray 62 and a first damper 64 that performs alignment for both ends (both ends in the direction orthogonal to the transport direction of sheets) of the sheets S accumulated on the first compiling tray 62.

Furthermore, the first sheet processing device 6 includes a needle-free binding mechanism 70 that performs, as a first binding processing, a binding processing (a needle-free binding processing) that does not use a staple needle with respect to the sheets S accumulated in the first compiling tray 62. The first sheet processing device 6 includes first ejection rolls 65 that discharge the sheet bundle, which is accumulated on the first compiling tray 62 and subjected to the needle-free binding processing by the needle-free binding mechanism 70, to the outside of the first sheet processing device 6.

The first sheet processing device 6 includes a first housing 66 that accommodates the first transport rolls 61, the first compiling tray 62, the first paddle 63, the first damper 64, the first ejection rolls 65, and the needle-free binding mechanism 70. In the first sheet processing device 6 of the present exemplary embodiment, the first housing 66 is removably mounted on the first mounting unit provided in the housing 30 of the image forming apparatus 2.

In addition, the first sheet processing device 6 includes a processing device side stacking unit 67 as an example of a stacking unit in which the sheets S discharged by the first ejection rolls 65 are stacked. In the image forming system 1 of the present exemplary embodiment, the height from the installation surface of the image forming apparatus 2 to the processing device side stacking unit 67 of the first sheet processing device 6 is higher than the height from the installation surface to a body side stacking unit 33.

The first compiling tray 62 is provided with a bottom part 62a that has a top surface on which the sheets S are stacked and an end guide 62b formed on a surface intersecting with the bottom part 62a and aligns the end portions of the sheets S in the transport direction (the direction S2 in FIG. 3) when the sheet bundle is generated, as illustrated in FIG. 3.

The first paddle 63 is rotatably provided at a position where it is opposite to the bottom part 62a of the first compiling tray 62. The first paddle 63 rotates in an R direction in FIG. 3 in a state where it is in contact with the sheet S so as to press the sheets S, which are transported in a direction S1 in FIG. 3 by the first transport rolls 61, in the direction S2 on the first compiling tray 62.

The first damper 64 is provided at a position where it is opposite to the bottom part 62a of the first compiling tray 62 to be movable in a direction vertical to the page surface in FIG. 3. The first damper 64 aligns the sheets S accumulated in the first compiling tray 62 in a direction orthogonal to the direction S2 (the width direction of the sheet S). As illustrated in FIG. 4, the first damper 64 is constituted with a damper 64a and a damper 64b which are aligned in a direction orthogonal to the direction S2. The damper 64a and the damper 64b are configured to receive a driving force from a driving motor (not illustrated) to be independently movable in Y1 and Y2 directions of FIG. 4 (directions intersecting with the direction S3), respectively.

As illustrated in FIG. 3, the first ejection rolls 65, are constituted with an ejection roll 65a and an ejection roll 65b which are opposite to each other across a sheet S transported to the first compiling tray 62. When a sheet bundle is produced (compiled) in the first compiling tray 62, the ejection roll 65a is raised (moves in the direction Q2), and the ejection roll 65a and the ejection roll 65b are spaced apart from each other. When the sheet bundle is transported toward the outside of the apparatus housing (in the direction S3 of FIG. 4), the ejection roll 65a is lowered (moves in the direction Q1) and comes in contact with the sheet bundle. The first ejection rolls 65 rotates in T1 direction of FIG. 3 in a state where they are in contact with the sheet bundle so as to transport the sheet bundle in the direction S3 of the downstream side.

The needle-free binding mechanism 70 performs a processing of binding the upstream side end of the sheet bundle in the direction S3, which is aligned on the first compiling tray 62, by pressing the sheet bundle to rupture and press-bond the fibers of the sheets S without using a staple needle. Details of the configuration of the needle-free binding mechanism 70 and the needle-free binding processing will be described later.

The needle-free binding mechanism 70 is configured to receive a driving force from a driving motor (not illustrated) to be movable on a rail (not illustrated). The rail is formed to follow a longitudinal direction of the end guide 62b (up-down direction in FIG. 4) around the first compiling tray 62 (see arrow A of FIG. 4).

Subsequently, descriptions will be made on a procedural sequence of the needle-free binding processing performed in the first sheet processing device 6 of the present exemplary embodiment.

The sheets S carried into the first sheet processing device 6 from the image forming apparatus 2 are transported in the direction S1 by first transport rolls 61 in a state where the image forming surfaces thereof are directed upward. The sheets S transported in the direction S1 are transported toward the first compiling tray 62 between the first ejection rolls 65 and the first paddle 63. Upon arriving at the first compiling tray 62, the sheets S are pressed in a direction S2 by the rotation of the first paddle 63 in the direction R illustrated in FIG. 3 so that the rear ends of the sheets S abut against the end guide 62b to be aligned. In this way, the sheets S are received in the first compiling tray 62, and the first dampers 64 (dampers 64a and 64b) move in directions Y1 and Y2 in FIG. 4 in according to a timing at which the sheets S arrive at the end guide 62b, and perform the positional alignment of both ends of the sheets S from sheet to sheet.

Next, sheets S are accumulated in the first compiling tray 62 by a predetermined number and aligned to generate a sheet bundle. As described above, respective sheets S are stacked in a state where the image forming surfaces are directed vertically upward. The needle-free binding mechanism 70 moves to a predetermined binding position and the binding processing is performed.

In a case where the binding is performed at a single position of the sheet bundle on the first compiling tray 62, the needle-free binding mechanism 70 stops at a predetermined home position and performs the needle-free binding processing subsequently at a required timing. Meanwhile, in a case where the binding is performed at two positions of the sheet bundle, the needle-free binding mechanism 70 is moved to the predetermined binding position on the rail by a driving force of the driving motor, and performs the needle-free binding processing at the two positions of the sheet bundle.

Thereafter, the first ejection rolls 65 rotate in the direction T1 so that the sheet bundle subjected to the binding processing is discharged to the processing device side stacking unit 67 in a state where the image forming surfaces are directed vertically upward.

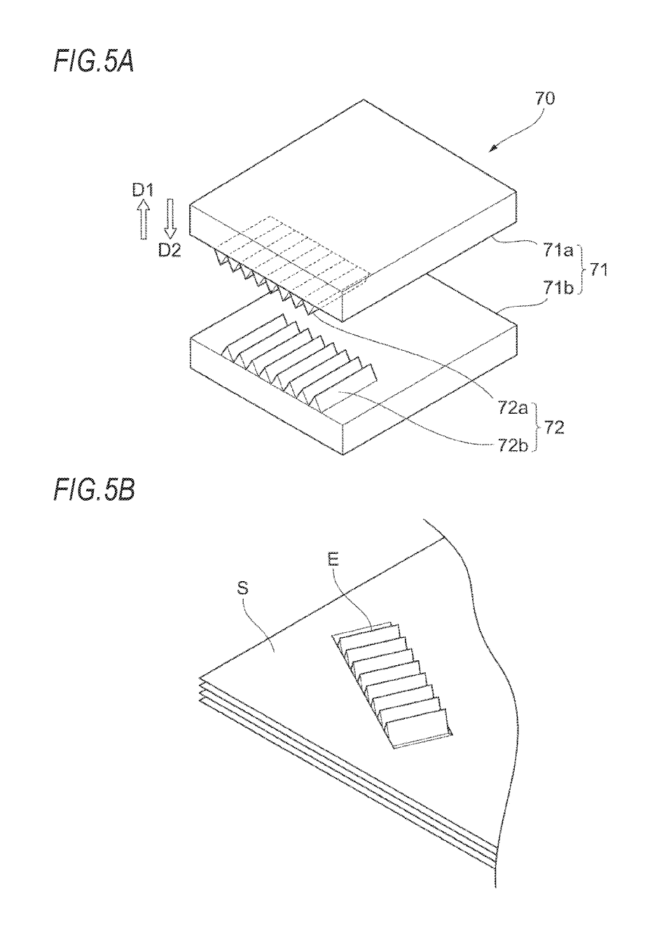

Subsequently, descriptions will be made on a configuration of the needle-free binding mechanism 70 and the needle-free binding processing. FIG. 5A and FIG. 5B are views illustrating the needle-free binding mechanism 70 according to the present exemplary embodiment. FIG. 5A schematically illustrates the needle-free binding mechanism 70 in a perspective view, and FIG. 5B illustrates an end part of the sheet bundle subjected to the binding processing by the needle-free binding mechanism 70.

The needle-free binding mechanism 70 of the present exemplary embodiment includes pressing units 71 that come closer to each other so as to supply a pressure for processing an end portion of sheets S and embossing mark forming units 72 that receive the pressure from the pressing units 71 to process the sheets S in order to bind the sheets S.

The pressing units 71 are constituted with an upper pressing unit 71a disposed to be opposite to the image forming surface side of the sheet bundle generated in the first compiling tray 62 (see FIG. 3) and a lower pressing unit 71b disposed to face a surface of the sheet bundle which is opposite to the image forming surface of the sheet bundle. The upper pressing unit 71a is provided to be movable back and forth in relation to the lower pressing unit 71b by an upper pressing unit motor (not illustrated) (see arrows D1 and D2 in FIG. 5A). The upper pressing unit 71a and the lower pressing unit 71b are configured to apply pressure to a sheet bundle generated in the first compiling tray 62.

The embossing mark forming units 72 constituted with a convex unit 72a provided on the upper pressing unit 71a and protruding toward the lower pressing unit 71b and a receiving unit 72b provided on the lower pressing unit 71b and including concave and convex portions corresponding to a shape of the convex unit 72a. The convex unit 72a and the receiving unit 72b are configured to process the sheet bundle inserted therebetween.

Specifically, the convex unit 72a is provided with concave and convex portions on the surface that is opposite to the receiving unit 72b, and the receiving unit 72b is provided with concave and convex portions on the surface that is opposite to the convex unit 72a. In addition, the surface of the convex unit 72a, on which the concave and convex portions are formed, and the surface of the receiving unit 72b, on which the concave and convex portions are formed, are substantially parallel to each other, and are disposed such that the convex portions of the convex unit 72a and the concave portions of the receiving unit 72b are disposed to be engaged with each other. The convex unit 72a and the receiving unit 72b are configured in such that, when a pressure is received by the pressing units 71, the convex unit 72a and the receiving unit 72b are engaged with each other to process the sheet bundle.

As illustrated in FIG. 5B, concave and convex portions are formed in the processed portions of the sheets S (sheet bundle) over an overlapping direction of the sheets S to correspond to the shapes of the convex unit 72a and the receiving unit 72b. As a result, the fibers constituting the sheets S are ruptured in the processed portions of the sheets S such that the sheets S are press-bonded to each other. As a result, embossing marks E are formed to bind the sheet bundle without using a staple needle.

### (Description of Second Sheet Processing Device 8)

Referring back to FIG. 2, the second sheet processing device 8 of the present exemplary embodiment includes second transport rolls 81 that further transport the sheet discharged from the second exit port 32 of the image forming apparatus 2 to the downward side and a second compiling tray 82 in which the sheets each having an image formed thereon are accumulated by a predetermined number. In addition, the second sheet processing device 8 includes a rotating second paddle 83 that presses the rears end of the sheets S toward an end guide 82a of the second compiling tray 82 and a second damper 84 that performs positional alignment for both ends of the sheets accumulated on the second compiling tray 82 (both ends in the direction orthogonal to the transport direction of the sheets).

Furthermore, the second sheet processing device 8 includes a needle binding mechanism 90 that performs a binding processing using a staple needle (needle binding processing) on the sheets accumulated in the second compiling tray 82, as the second binding processing. In addition, the second sheet processing device 8 includes second ejection rolls 85 that discharge the sheet bundle accumulated on the second compiling tray 82 and subjected to the needle binding processing by the needle binding mechanism 90 to the body side stacking unit 33.

In addition, the second sheet processing device 8 includes a second housing 86 that accommodates the second transport rolls 81, the second compiling tray 82, the second paddle 83, the second damper 84, the second ejection rolls 85, and the needle binding mechanism 90.

The second transport rolls 81, the second compiling tray 82, the second paddle 83, the second damper 84, and the second ejection rolls 85 of the second sheet processing device 8 have the same configurations as the first transport rolls 61, the first compiling tray 62, the first paddle 63, the first damper 64, the first ejection rolls 65 of the first sheet processing device 6, respectively. Therefore, detailed descriptions of the structures and operations thereof will be omitted.

Subsequently, descriptions will be made on the needle binding processing performed in the second sheet processing device 8 of the present exemplary embodiment.

Sheets carried into the second sheet processing device 8 from the image forming apparatus 2 are transported in a state where the image forming surfaces are directed vertically downward. The transported sheets are transported toward the second compiling tray 82 between the second ejection rolls 85 and the second paddle 83. The sheets, which arrive at the second compiling tray 82, are pressed by the rotation of the second paddle 83, and the rear ends of the sheets abut against the end guide 82b to be aligned. In this way, the sheets are received in the second compiling tray 82, and the second damper 84 moves according to a timing at which the sheets arrive at the end guide 82b so as to align both ends of the sheets from sheet to sheet.

Next, the sheets are accumulated in the second compiling tray 82 by a predetermined number and aligned to generate a sheet bundle. Here, as described above, respective sheets are stacked in a state where the image forming surfaces are directed vertically downward. The needle binding mechanism 90 moves to a predetermined binding position so that the binding processing using the staple needle is performed. Specifically, a staple needle is pressed to the sheet bundle generated in the second compiling tray 82 from the image forming surface side by the needle binding mechanism 90 such that the binding processing is performed.

Thereafter, when the second ejection rolls 85 rotate, the sheet bundle subjected to the binding processing is discharged to the body side stacking unit 33 of the image forming apparatus 2 in a state where the image forming surfaces are directed vertically downward.

### (Description of Control by Controller 5)

In the image forming system 1 of the present exemplary embodiment, when a binding processing is performed on a sheet bundle, any of the needle-free binding processing by the first sheet processing device 6 and the needle binding processing by the second sheet processing device 8 is selected. In the image forming system 1, a user selection mode, in which a selection is made by the user through, for example, an operation reception apparatus 4 and an automatic selection mode, in which a selection is made automatically by the controller 5, are set as modes for selecting the needle-free binding processing and the needle binding processing.

However, in the needle-free binding processing for binding a sheet bundle without using a staple needle by the needle-free binding mechanism 70 of the first sheet processing device 6, the binding of the sheet bundle tends to be easily released compared to the needle binding processing for binding the sheet bundle using the staple needle by the needle binding mechanism 90 of the second sheet processing device 8. In other words, a bonding strength between the sheets constituting the sheet bundle tends to be small in the needle-free binding processing compared to the needle binding processing. In particular, in the needle-free binding processing of the first sheet processing device 6, the binding of the sheet bundle is easily released when the number of sheets to be bound as a sheet bundle is large.

On the contrary, in the image forming system 1 of the present exemplary embodiment, the needle binding processing by the second sheet processing device 8 is selected based on the control by the controller 5 when the number of sheets to be bound as the sheet bundle is large in the automatic selection mode.

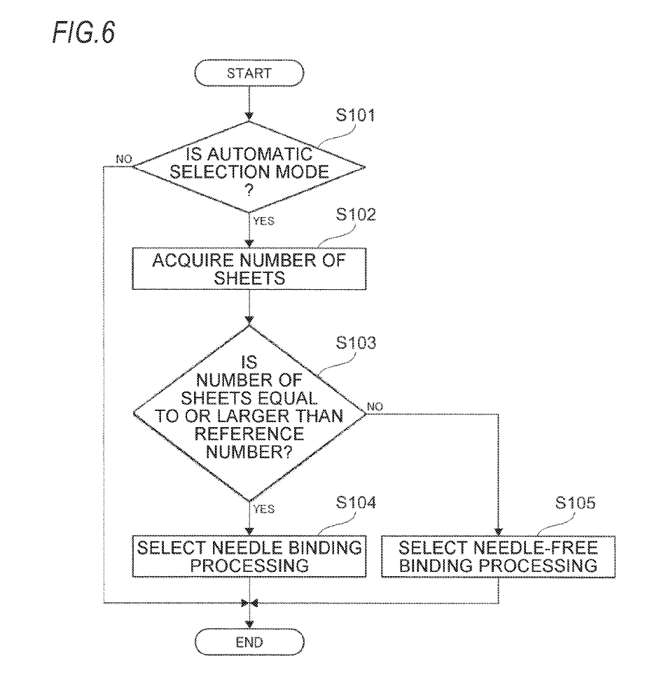

Hereinafter, descriptions will be made on the procedural sequence of selecting the needle-free binding processing by the first sheet processing device 6 or the needle binding processing by the second sheet processing device 8 according to the control of the controller 5. FIG. 6 is a flowchart illustrating a procedural sequence of selection by the controller 5.

In a case where a user issues an instruction to accumulate plural sheets to perform the binding processing for the sheet bundle using, for example, the operation reception apparatus 4, the controller 5 determines whether the automatic selection mode is set (Step 101).

When the automatic selection mode is not set (“NO” at Step 101), that is, when the user selection mode is set, the needle-free binding processing by the first sheet processing device 6 or the needle binding processing by the second sheet processing device 8 is selected based on the selection by the user, and a series of processings are ended.

Meanwhile, when the automatic selection mode is set (“YES” at Step 101), the controller 5 acquires the number of sheets to be subjected to the binding processing (Step 102), and determines whether the acquired number of sheets is equal to or larger than the predetermined reference number of sheets (e.g., ten (10) sheets) (Step 103).

When the number of sheets is equal to or larger than the reference number of sheets (“YES” at Step 103), the controller 5 selects the needle binding processing to be performed by the second sheet processing device 8 (Step 104), and terminates a series of processings.

On the other hand, when the number of sheets is less than the reference number of sheets (“NO” at Step 103), the controller 5 selects the needle-free binding processing to be performed by the first sheet processing device 6 (Step 105), and terminates a series of processings.

In addition, based on a selection result by each selection mode, the controller 5 controls the distribution mechanism 43 to distribute the sheets, which are formed with an image in the image forming unit 10, to the first sheet processing device 6 or the second sheet processing device 8. Specifically, in a case where the needle-free binding processing is selected, the controller 5 transports the sheets to the first transport path 41 and distributes the sheets to the first sheet processing device 6 by the distribution mechanism 43. In a case where the needle binding processing is selected, the controller 5 transports the sheets to the second transport path 42 and distributes the sheets to the second sheet processing device 8 by the distribution mechanism 43.

In this way, in the image forming system 1 of the present exemplary embodiment, the needle binding processing by the second sheet processing device 8 is selected when the number of sheets constituting a sheet bundle is larger than the reference number of sheets in the automatic selection mode. Accordingly, the release of the binding of the sheet bundle may be suppressed compared to, for example, a case where the needle-free binding processing by the first sheet processing device 6 is selected when the number of sheets constituting the sheet bundle is larger than the reference number of sheets.

In addition, in the image forming system 1 of the present exemplary embodiment, the needle-free binding processing by the first sheet processing device 6 is selected when the number of sheets constituting a sheet bundle is less than the reference number of sheets in the automatic selection mode. Accordingly, the consumption of the staple needle may be reduced compared to, for example, a case where the needle binding processing by the second sheet processing device 8 is selected when the number of sheets constituting a sheet bundle is less than the reference number of sheets.

As described above, the image forming system 1 of the present exemplary embodiment separately includes the first sheet processing device 6 including the needle-free binding mechanism 70 to perform the needle-free binding processing without using a staple needle on sheets and the second sheet processing device 8 including the needle binding mechanism 90 to perform the needle binding processing using a staple needle on sheets. More specifically, in the image forming system 1 of the present exemplary embodiment, the first sheet processing device 6 and the second sheet processing device 8 are configured to be individually detachable from/attachable to different positions of the housing 30 of the image forming apparatus 2.

By employing such a configuration, the image forming system 1 of the present exemplary embodiment is able to respond to a user who requests both the needle binding processing and the needle-free binding processing and a user who requests one of the needle binding processing and the needle-free binding processing, as the binding processing for the sheet. That is, both the first sheet processing device 6 and the second sheet processing device 8 may be mounted on the image forming apparatus 2 in the image forming system 1 for a user who requests both the needle binding processing and the needle-free binding processing.

On the contrary, for example, the second sheet processing device 8 may be removed and only the first sheet processing device 6 may be mounted in the image forming system 1 for a user who requests only the needle-free binding processing. Similarly, the first sheet processing device 6 may be removed and only the second sheet processing device 8 may be mounted in the image forming system 1 for a user who requests only the needle binding processing. In this case, for example, the configuration of the image forming system 1 is simplified in the image forming system 1 compared to the case where both the first sheet processing device 6 and the second sheet processing device 8 are mounted.

In this way, in the present exemplary embodiment, the image forming system 1 according to a request of a user is realized by a simple operation of attaching/detaching the first sheet processing device 6 or the second sheet processing device 8 to/from the image forming apparatus 2.

Furthermore, in the image forming system 1 of the present exemplary embodiment, for example, when a problem occurs in or maintenance is performed on one of the first sheet processing device 6 and the second sheet processing device 8, only the one of the first sheet processing device 6 and the second sheet processing device 8 is removed from the image forming apparatus 2 such that the binding processing may be continued in the other one of the first sheet processing device 6 and the second sheet processing device 8. For example, even when the first sheet processing device 6 is removed from the image forming apparatus 2 for the maintenance, the needle binding processing by the needle binding mechanism 90 may be continued in the second sheet processing device 8.

For this reason, in the present exemplary embodiment, it is possible to suppress the occurrence of a situation in which the binding processing cannot be performed compared to a case where the needle-free binding mechanism 70 and the needle binding mechanism 90 are provided in the same apparatus.

In the image forming system 1 of the present exemplary embodiment, the first sheet processing device 6 including the needle-free binding mechanism 70 is mounted on the outside of the installation range W of the image forming apparatus 2. Accordingly, in the image forming system 1, the user can easily recover a sheet bundle subjected to the needle-free binding processing and discharged to the processing device side stacking unit 67 compared to a case where the first sheet processing device 6 is mounted on the inside of the installation range W. In other words, the user can easily reach a sheet bundle discharged to the processing device side stacking unit 67 compared to the case where the first sheet processing device 6 is mounted on the inside of the installation range W.

Here, as described above, in the needle-free binding processing, the binding of the sheet bundle tends to be easily released compared to the needle binding processing. On the contrary, in the present exemplary embodiment, the first sheet processing device 6 is mounted on the outside of the installation range W of the image forming apparatus 2 to easily recover the sheet bundle and thus, the release of the binding is suppressed when the sheet bundle is recovered.

In this example, the first sheet processing device 6 is configured such that the whole of the first sheet processing device 6 is positioned outside the installation range W of the image forming apparatus 2 in its entirety. However, at least the processing device side stacking unit 67 of the first sheet processing device 6 may be positioned outside the installation range W from a viewpoint that the sheet bundle is easily recovered after the needle-free binding processing.

Furthermore, in the image forming system 1 of the present exemplary embodiment, a height from the installation surface on which the image forming apparatus 2 is installed to the first sheet processing device 6 is higher than a height from the installation surface to the second sheet processing device 8. Accordingly, in the image forming system 1, the user can easily recover a sheet bundle subjected to the needle-free binding processing and discharged to the processing device side stacking unit 67 compared to a case where the height from the installation surface to the first sheet processing device 6 is lower than the second sheet processing device 8. More specifically, a user can easily reach the sheet bundle discharged to the processing device side stacking unit 67, for example, even without bending his/her body. As a result, in the present exemplary embodiment, the release of the binding is suppressed when the sheet bundle is recovered.

Similarly, from a view point that in order to easily recover a sheet bundle after being subjected to the needle-free binding processing, at least the processing device side stacking unit 67, to which the sheet bundle subjected to the needle-free binding processing in the first sheet processing device 6 is discharged, may be positioned vertically above the body side stacking unit 33, to which the sheet bundle subjected to the needle binding processing in the second sheet processing device 8 is discharged.

In addition, in the image forming system 1 of the present exemplary embodiment, the length of the second transport path 42 in which the sheet is transported from the image forming unit 10 toward the second sheet processing device 8 is shorter than the length of the first transport path 41 in which the sheet is transported from the image forming unit 10 toward the first sheet processing device 6. Accordingly, in a case where the sheet transport speeds in the first transport path 41 and the second transport path 42 are equal to each other, the time required until a sheet, which is formed with an image in the image forming unit 10, arrives at the second sheet processing device 8 is reduced compared to the time required until a sheet, which is formed with an image in the image forming unit 10, arrives at the first sheet processing device 6.

Here, as described above, the needle binding processing performed in the second sheet processing device 8 makes the release of the binding of a sheet bundle difficult compared to the needle-free binding processing performed in the first sheet processing device 6. For this reason, for example, in a case where the number of sheets to be subjected to the binding processing is large, the needle binding processing by the second sheet processing device 8 is often selected. In a case where the needle binding processing is performed by the second sheet processing device 8, the operations of transporting the sheets to the second sheet processing device 8 and accumulating the sheets on the second compiling tray 82 are repeated. Thus, the time required for the needle binding processing is apt to be lengthened in a case where the number of sheets is large.

On the contrary, in the present exemplary embodiment, the second transport path 42 is made to be short compared to the first transport path 41, and the time required until the sheet arrives at the second sheet processing device 8 is shortened. Thus, the time required for the needle binding processing in the second sheet processing device 8 is suppressed from being excessively lengthened even if the number of sheets is large.

In the image forming system 1 of the present exemplary embodiment, the sheet is transported in a state where the image forming surface is directed vertically downward (face-down state) in the second sheet processing device 8. Then, a needle binding processing is performed by pressing a staple needle to the sheet from the image forming surface side.

In general, in a sheet processing device performing a needle binding processing, a staple needle is often pressed to the sheet bundle from the image forming surface side in order to make an appearance of the sheet bundle look better after the binding processing. Accordingly, in the image forming system 1 of the present exemplary embodiment, for example, a binding position or a direction of a staple needle with respect to sheets may be controlled by software that is compatible with other sheet processing devices in the second sheet processing device 8.

Whereas, in the first sheet processing device 6, sheets are transported in a state where the image forming surfaces are directed vertically upward (face-up state) so that a needle-free processing is performed. Accordingly, the first sheet processing device 6 needs to perform the control of, for example, a binding position or a binding direction with respect to sheets to be different from that of the second sheet processing device 8.

Here, a binding mark (embossing mark E) formed by a needle-free binding processing in the first sheet processing device 6 has an area that is larger than that of a binding mark (a staple needle) formed by a needle binding processing in the second sheet processing device 8. Furthermore, in the first sheet processing device 6, a sheet bundle subjected to the needle-free binding processing is discharged to the processing device side stacking unit 67 in a state where the image forming surfaces are directed vertically upward, in other words, in a state where the image forming surfaces are exposed. For that reason, it becomes easy to visually check, for example, the positional relationship between an image formed on the sheet and the embossing mark E on the sheet bundle subjected to the needle-free binding processing in the first sheet processing device 6. Accordingly, even if the control of, for example, the binding position in the first sheet processing device 6 is performed to be different from that of the second sheet processing device 8, an occurrence of, for example, a problem of repeating the binding processing in a state where an image and an embossing mark E overlap with each other is suppressed.

### Second Exemplary Embodiment

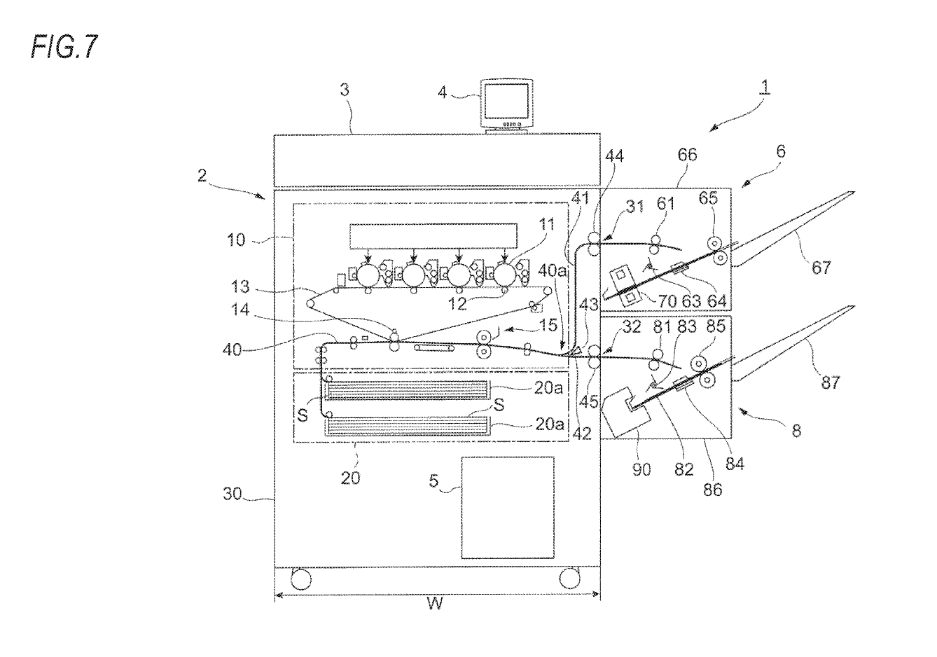

Subsequently, descriptions will be made on a second exemplary embodiment of the present invention. FIG. 7 is a view illustrating an overall configuration of an image forming system 1 according to the second exemplary embodiment. In the image forming system 1 of the second exemplary embodiment, the constitutional components similar to those of the first exemplary embodiment are denoted by the similar reference numerals and detailed descriptions thereof will be omitted.

As in the first exemplary embodiment, the image forming system 1 of the second exemplary embodiment includes an image forming apparatus 2, an image reader 3, an operation reception apparatus 4, and a controller 5. The image forming system 1 of the second exemplary embodiment includes a first sheet processing device 6 that performs a needle-free binding processing on sheets and a second sheet processing device 8 that performs a needle binding processing on sheets S. The second sheet processing device 8 has the same configuration as that of the first exemplary embodiment except that the second sheet processing device 8 includes a processing device side stacking unit 87 to which a sheet bundle subjected to a needle binding processing by the needle binding mechanism 90 is discharged. The first sheet processing device 6 has the same configuration as that of the first exemplary embodiment except for the direction and the image forming surfaces of sheets S to be transported.

In the image forming system 1 of the second exemplary embodiment, the first sheet processing device 6 and the second sheet processing device 8 are provided to be individually detachable from the housing 30 of the image forming apparatus 2.

In addition, as illustrated in FIG. 7, the first sheet processing device 6 and the second sheet processing device 8 are provided outside the installation range W on which the image forming apparatus 2 is installed. Accordingly, the user can easily recover a sheet bundle discharged to the processing device side stacking unit 67 or the processing device side stacking unit 87 compared to a case where the first sheet processing device 6 and the second sheet processing device 8 are provided inside the installation range W.

Furthermore, as illustrated in FIG. 7, the first sheet processing device 6 and the second sheet processing device 8 are provided in parallel to each other in the vertical direction with respect to the housing 30 of the image forming apparatus 2. Specifically, the first sheet processing device 6 and the second sheet processing device 8 are provided side by side to be aligned such that the first sheet processing device 6 is positioned vertically above the second sheet processing device 8 with respect to the housing 30 of the image forming apparatus 2. The height from the installation surface, on which the image forming apparatus 2 is installed, to the first sheet processing device 6 is higher than the height from the installation surface to the second sheet processing device 8. The user can easily recover the sheet bundle subjected to the needle-free binding processing by the first sheet processing device 6 and discharged to the processing device side stacking unit 67.

In the image forming system 1 of the second exemplary embodiment, the shape of the sheet transport path 40 of the image forming apparatus 2 is different from that of the first exemplary embodiment.

Specifically, as illustrated in FIG. 7, in the sheet transport path 40, the transport direction of sheets S in the image forming unit 10, the exit direction of sheet S discharged from the first exit port 31 to the first sheet processing device 6 through the first transport path 41, and the exit direction of sheets S discharged from the second exit port 32 to the second sheet processing device 8 through the second transport path 42 are set to be the same.

In addition, in the image forming apparatus 2 of the second exemplary embodiment, the sheets S, which are formed with an image in the image forming unit 10, are transported in the first transport path 41 and the second transport path 42 of the sheet transport path 40 in a state where the image forming surfaces are directed vertically upward (face-up state).

Accordingly, in the image forming system 1 of the second exemplary embodiment, the sheets S are transported to the first sheet processing device 6 and the second sheet processing device 8 in a state where the image forming surfaces are directed vertically upward. For this reason, in the second exemplary embodiment, the binding position or the binding direction for the sheets S may be controlled by the same software in the first sheet processing device 6 and the second sheet processing device 8.

In the descriptions of the first exemplary embodiment and the second exemplary embodiment, descriptions have been made on a case where the concave and convex portions are formed on a sheet bundle so as to cause the sheets to be press-bonded to each other, as a needle-free binding processing performed by the needle-free binding mechanism 70 of the first sheet processing device 6 without using a stapler needle. However, the needle-free binding processing is not limited thereto.

For example, in the first sheet processing device 6, a sheet bundle may be bound by, for example, forming a slit and a tongue-shaped piece punched out except one end thereof on the sheets (sheet bundle), and bending the tongue piece to be inserted into the slit. In addition, the needle-free binding processing performed in the first sheet processing device 6 may be, for example, a binding processing using an adhesive or the like.

In addition, in the above description, a needle-free binding processing that does not use a staple needle and is performed by the needle-free binding mechanism 70 has been described as an example of the first binding processing, and a needle binding processing that uses a staple needle and is performed by the needle binding mechanism 90 has been described as an example of the second binding processing. However, the first binding processing and the second binding processing are not limited thereto. When a bonding strength between the sheets by the first binding processing is small compared to a bonding strength between the sheets by the second binding processing, the first binding processing and the second binding processing may be the same types of binding processings.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system comprising:
an apparatus body including an image forming unit configured to form an image on a sheet;
a first sheet processing device mounted on the apparatus body, and configured to perform a first binding processing on plural sheets each of which is formed with an image by the image forming unit; and
a second sheet processing device mounted on the apparatus body at a position different from that of the first sheet processing device, and configured to perform a second binding processing different from the first binding processing on the plural sheets, each of which is formed with an image by the image forming unit.

2. The image forming system according to claim 1, wherein the first sheet processing device and the second sheet processing device are individually detachable from the apparatus body.

3. The image forming system according to claim 1, wherein the first sheet processing device is mounted on the apparatus body such that the first sheet processing device performs the first binding processing in which a bonding strength between the sheets is smaller than that in the second binding processing, and at least a stacking unit in which the sheets after being subjected to the first binding processing are stacked is installed outside an installation range in which the apparatus body is installed.

4. The image forming system according to claim 2, wherein the first sheet processing device is mounted on the apparatus body such that the first sheet processing device performs the first binding processing in which a bonding strength between the sheets is smaller than that in the second binding processing, and at least a stacking unit in which the sheets after being subjected to the first binding processing are stacked is installed outside an installation range in which the apparatus body is installed.

5. The image forming system according to claim 1, wherein the first sheet processing device is mounted on the apparatus body such that the first sheet processing device performs the first binding processing in which a bonding strength between the sheets is smaller than that in the second binding processing and at least a stacking unit in which the sheets after being subjected to the first binding processing are stacked is positioned vertically above another stacking unit in which the sheets after being subjected to the second binding processing in the second sheet processing device are stacked.

6. The image forming system according to claim 2, wherein the first sheet processing device is mounted on the apparatus body such that the first sheet processing device performs the first binding processing in which a bonding strength between the sheets is smaller than that in the second binding processing and at least a stacking unit in which the sheets after being subjected to the first binding processing are stacked is positioned vertically above another stacking unit in which the sheets after being subjected to the second binding processing in the second sheet processing device are stacked.

7. The image forming system according to claim 1, wherein the second sheet processing device is configured to perform the second binding processing in which a bonding strength between the sheets is larger than that in the first binding processing, and
a sheet transport path from the image forming unit to the second sheet processing device is shorter than another sheet transport path from the image forming unit to the first sheet processing device.

8. The image forming system according to claim 2, wherein the second sheet processing device is configured to perform the second binding processing in which a bonding strength between the sheets is larger than that in the first binding processing, and
a sheet transport path from the image forming unit to the second sheet processing device is shorter than another sheet transport path from the image forming unit to the first sheet processing device.

9. The image forming system according to claim 1, further comprising:
a selection unit configured to select the second binding processing by the second sheet processing device or the first binding processing by the first sheet processing device,
wherein the second sheet processing device is configured to perform the second binding processing in which a bonding strength between the sheets is larger than that in the first binding processing, and
the selection unit is configured to select the second binding processing in a case where a number of sheets to be subjected to a binding processing is equal to or larger than a predetermined reference number.

10. The image forming system according to claim 2, further comprising:
a selection unit configured to select the second binding processing by the second sheet processing device or the first binding processing by the first sheet processing device,
wherein the second sheet processing device is configured to perform the second binding processing in which a bonding strength between the sheets is larger than that in the first binding processing, and
the selection unit is configured to select the second binding processing in a case where a number of sheets to be subjected to a binding processing is equal to or larger than a predetermined reference number.

11. The image forming system according to claim 1,
wherein the first sheet processing device is configured to perform the first binding processing on the plural sheets stacked in a state where image forming surfaces, on each of which the image is formed by the image forming unit, are directed upward, by forming concave and convex portions over an overlapping direction of the sheets, and
the second sheet processing device is configured to perform the second binding processing on the plural sheets stacked in a state where the image forming surfaces are directed downward, by causing a staple needle to penetrate the sheets from an image forming surface side.

12. The image forming system according to claim 2,
wherein the first sheet processing device is configured to perform the first binding processing on the plural sheets stacked in a state where image forming surfaces, on each of which the image is formed by the image forming unit, are directed upward, by forming concave and convex portions over an overlapping direction of the sheets, and
the second sheet processing device is configured to perform the second binding processing on the plural sheets stacked in a state where the image forming surfaces are directed downward, by causing a staple needle to penetrate the sheets from an image forming surface side.

13. The image forming system according to claim 3,
wherein the first sheet processing device is configured to perform the first binding processing on the plural sheets stacked in a state where image forming surfaces, on each of which the image is formed by the image forming unit, are directed upward, by forming concave and convex portions over an overlapping direction of the sheets, and
the second sheet processing device is configured to perform the second binding processing on the plural sheets stacked in a state where the image forming surfaces are directed downward, by causing a staple needle to penetrate the sheets from an image forming surface side.

14. The image forming system according to claim 4,
wherein the first sheet processing device is configured to perform the first binding processing on the plural sheets stacked in a state where image forming surfaces, on each of which the image is formed by the image forming unit, are directed upward, by forming concave and convex portions over an overlapping direction of the sheets, and
the second sheet processing device is configured to perform the second binding processing on the plural sheets stacked in a state where the image forming surfaces are directed downward, by causing a staple needle to penetrate the sheets from an image forming surface side.

15. The image forming system according to claim 5,
wherein the first sheet processing device is configured to perform the first binding processing on the plural sheets stacked in a state where image forming surfaces, on each of which the image is formed by the image forming unit, are directed upward, by forming concave and convex portions over an overlapping direction of the sheets, and
the second sheet processing device is configured to perform the second binding processing on the plural sheets stacked in a state where the image forming surfaces are directed downward, by causing a staple needle to penetrate the sheets from an image forming surface side.

16. The image forming system according to claim 6,
wherein the first sheet processing device is configured to perform the first binding processing on the plural sheets stacked in a state where image forming surfaces, on each of which the image is formed by the image forming unit, are directed upward, by forming concave and convex portions over an overlapping direction of the sheets, and
the second sheet processing device is configured to perform the second binding processing on the plural sheets stacked in a state where the image forming surfaces are directed downward, by causing a staple needle to penetrate the sheets from an image forming surface side.

17. The image forming system according to claim 7,
wherein the first sheet processing device is configured to perform the first binding processing on the plural sheets stacked in a state where image forming surfaces, on each of which the image is formed by the image forming unit, are directed upward, by forming concave and convex portions over an overlapping direction of the sheets, and
the second sheet processing device is configured to perform the second binding processing on the plural sheets stacked in a state where the image forming surfaces are directed downward, by causing a staple needle to penetrate the sheets from an image forming surface side.

18. The image forming system according to claim 8,
wherein the first sheet processing device is configured to perform the first binding processing on the plural sheets stacked in a state where image forming surfaces, on each of which the image is formed by the image forming unit, are directed upward, by forming concave and convex portions over an overlapping direction of the sheets, and
the second sheet processing device is configured to perform the second binding processing on the plural sheets stacked in a state where the image forming surfaces are directed downward, by causing a staple needle to penetrate the sheets from an image forming surface side.

19. The image forming system according to claim 9,
wherein the first sheet processing device is configured to perform the first binding processing on the plural sheets stacked in a state where image forming surfaces, on each of which the image is formed by the image forming unit, are directed upward, by forming concave and convex portions over an overlapping direction of the sheets, and
the second sheet processing device is configured to perform the second binding processing on the plural sheets stacked in a state where the image forming surfaces are directed downward, by causing a staple needle to penetrate the sheets from an image forming surface side.

20. The image forming system according to claim 10,
wherein the first sheet processing device is configured to perform the first binding processing on the plural sheets stacked in a state where image forming surfaces, on each of which the image is formed by the image forming unit, are directed upward, by forming concave and convex portions over an overlapping direction of the sheets, and
the second sheet processing device is configured to perform the second binding processing on the plural sheets stacked in a state where the image forming surfaces are directed downward, by causing a staple needle to penetrate the sheets from an image forming surface side.
